(19) United States
(12) Patent Application Publication
(10) Pub. No.: US 2017/0225960 A1
(43) Pub. Date: Aug. 10, 2017

(54) METHOD FOR THE PRODUCTION OF SULPHATE OF POTASH GRANULATES, SULPHATE OF POTASH GRANULATE OBTAINED THEREBY, AND USE THEREOF

(71) Applicant: K+S Kali GmbH, Kassel (DE)

(72) Inventors: Guido BAUCKE, Schenklengsfeld (DE); Marcel MUELLER-GOLDKUHLE, Essen (DE); Armin DIETRICH, Weissenborn (DE); Torsten REST, Heringen (DE); Roland KEIDEL, Petersberg-Steinau (DE); Ludger WALDMANN, Telgte (DE)

(73) Assignee: K+S Kali GmbH, Kassel (DE)

(21) Appl. No.: 15/515,419

(22) PCT Filed: Sep. 30, 2015
(86) PCT No.: PCT/DE2015/000497

§ 371 Date: Mar. 29, 2017

(30) Foreign Application Priority Data
Sep. 30, 2014 (DE) 10 2014 014 100.4

(51) Int. Cl. C01D 5/00; C05D 1/02; C05G 3/00; C05D 1/00

(52) U.S. Cl. CPC C01D 5/002; C01D 5/004; C05D 1/005; C05D 1/02; C05G 3/0058

(57) ABSTRACT

The invention relates to a method for producing sulphate of potash granulates, wherein 0.1 to 7.5 wt % of a potassium chloride are added to the sulphate of potash during the granulation process, the percentage by weight being in relation to the sulphate of potash used. In addition, 0.1 to 2.5 wt % of water are added prior to or during the granulation process. The invention also relates to the granulates obtained by said method as well as the use of potassium chloride for improving the mechanical properties of sulfate of potash granulates. The sulphate of potash granulates produced by the method of the invention have significantly greater bursting strength and significantly greater abrasion resistance than granulates known from the prior art.

The invention in hand concerns a method for producing potassium sulphate granules and the potassium sulphate granulate derived therefrom, as well as the use thereof.

Potassium sulphate is also known as SOP (sulphate of potash) and only occasionally found in its pure form (as arcanite) in nature, but contained in various minerals such as schonite, leonite, langbeineite, polyhalite and glaserite in the form of so-called double salts. Potassium sulphate can be industrially produced using the Mannheim process, for example, or from potassium chloride and kieserite, see also Winnacker, Küchler, WILEY VCH, Volume 8, 2005, p. 91f.

Potassium sulphate is used in agriculture as an ingredient of so-called potassium fertilizers.

Potassium sulphate combines the essential nutrients of potassium and sulphate in an optimal form that is easily water soluble and hence quickly available to the plants upon application, which are able to absorb it directly.

Mineral fertilizers are often used as granulates because of their advantageous handling characteristics in this form. Granulates will for example show a much lower tendency to form dust than the corresponding, finely divided mineral fertilizers in powder form, have a better storage and hygroscopic stability, and can be applied and dosed more evenly and easily by scattering. In addition to this, granulates are less vulnerable to being blown away by the wind when applied in open land.

Granulation is understood as the merging of powder particles or fine particles into larger particle units, the so-called granulates. It is particularly understood as various pressure and build-up agglomeration processes as well as related procedures where dispersed solid primary particles are clustered together, enlarging the particle size. Granulations are often performed in the presence of binders. The latter are liquid or solid substances whose adhesiveness ensures that the particles will cohere. The use of such binders becomes necessary where the granulation of particles would not lead to an adequately stable granulate without them. Well-known binders include water, gelatine, starch, lignosulphonates, hydrated lime and molasses. The choice of binder can have a decisive effect on the properties of the agglomerates, particularly on their mechanical stability (e.g. resistance to abrasion, breaking strength and bursting strength), hygroscopic stability and inclination to produce dust.

Granulation can be performed using a roller press, for example. In this type of pressure agglomeration, also known as pressure granulation, the fine particles or powder particles are compacted and/or compressed between two counterrotating drums that are braced in a frame construction. One of these drums is meanwhile often in a fixed and the other in a moveable design.

This moveable drum is usually supported by a hydraulic contact device ensuring a precise adjustability of the force applied in the pressing process. The total press force applied in the process is often also brought into relation with the working width of the drums and expressed as a specific press force or line force in N/cm, for example.

Gravity feeders or screw feeders are used as dosing units for a targeted conveyance of the substances to be compacted into the roller gap.

The substance to be compacted is compressed into slugs. To obtain granules of a defined particle size, the slugs are ground in mills after the compacting process. In the grading that follows next, the over- and undersized particles are separated out to obtain the desired range of particle sizes. Processes for granulating potassium sulphate powder/fine potassium sulphate particles are known from the state of the art.

DE 2810640 C2 describes a granulation process where the temperature of a fine-grained material containing potassium or ammonium salts is brought to 40 to 50° C. prior to pressing and the material is then pressed. The mechanical stabilities achievable with this granulation process are still in need of improvement.

WO 2007/071175 describes a method for producing granulated potassium sulphate with corn starch as a binder.

A process and experimental plant for granulating potassium sulphate are known from “Die Granulierung von Kaliumsulfat”, A. Hollstein, Kali and Steinsalz, vol. 7 (1979), issue 12. The addition of water and/or steam before the nip is mentioned. The strength properties exhibited by the products created are still in need of improvement.

Compounds containing mineral oil, vegetable oil, glycerine or polyethylene glycol are suggested in the state of the art to reduce the dust formation from abrasion.

The invention is based on the task of providing a process for granulating potassium sulphate salt mixtures with the fractions described below. The granulates produced by this method are meant to have a greater mechanical stability and particularly intended to be distinguished by a high burst strength and low abrasion.

It was surprisingly found that the set task is solved by granulating a mixture that largely consists of potassium sulphate and potassium chloride while adding water, with the potassium chloride used in a quantity of 0.1 to 7.5% by weight, preferably 1.8 to 4.5% by weight, especially preferably 2.5 to 4.3% by weight, in each case calculated as the weight proportion of the potassium chloride used in relation to the potassium sulphate used.

In comparison with conventional methods, the inventive method for producing potassium sulphate granulates permits the production of potassium sulphate granulates whose granules harden more quickly, thus reducing the maturing period of the granules. The granulates obtained in this manner exhibit uniform particle size distributions and densities and have the required, good stability qualities, especially a good mechanical stability such as fracture strength and/or low abrasion, and can largely be handled and mixed without damage.

The invention therefore concerns a method for producing potassium sulphate granulates, including the granulation of potassium sulphate, that is characterized by potassium chloride and/or an aqueous potassium chloride solution being added to the potassium sulphate in the granulation process in a quantity of 0.1 to 7.5% of KCl by weight, relating to the potassium sulphate used.

A further subject matter of the invention is the potassium sulphate granulate, particularly with a potassium chloride content ranging between 1.8 and 4.5%, obtainable by way of the inventive method.

Another subject matter of the invention is the use of solid, fine potassium chloride and/or an aqueous potassium chloride solution for improving the mechanical properties of potassium sulphate granulates, particularly for increasing the burst strength and/or abrasion resistance.

According to the invention, the potassium chloride with water/steam and/or potassium chloride solution are both present in the granulation process. This can be achieved by mixing the potassium chloride with the potassium sulphate to be granulated and moistening it with water and/or steam at the same time or later. An aqueous potassium chloride solution can also be used in place of the water.

These additives can either be added to the potassium sulphate in a mixer that precedes the press, a conveyance vehicle and/or in the feed shaft or apportioning device of the roller press.

In one embodiment, the total quantity of potassium chloride is added in the form of an aqueous solution.

In a further embodiment, KCl is added in a solid aggregate state and as KCl solution.

For the purposes of the present invention, after-treatment is understood as the addition of water or an aqueous solution to the granulate after the grading.

The granulation of the process according to the invention can be performed in analogy to the agglomeration procedures known from the state of the art, such as pressure or build-up agglomeration, for example, as described in Wolfgang Pietsch, Agglomeration Processes, Wiley-VCH, 1^{st} ed., 2002, and in G. Heinze, Handbuch der Agglomerationstechnik, Wiley-VCH, 2000, for example.

The granulation of the inventive process is preferably performed as pressure agglomeration.

In pressure agglomeration, the granulation is performed by compressing the salt mixture containing potassium sulphate and potassium chloride in the presence of water and/or steam. The potassium chloride can be added as a solid and/or in the form of an aqueous solution.

The KCl should be added as shortly before the pressing as possible.

In a preferred embodiment of the invention, the potassium salt is added in the form of a dust with a maximum particle size of 200 μm, or in the form of an aqueous solution.

In a further preferred embodiment of the invention, part of the potassium salt is added in the form of a dust with a maximum particle size of 200 μm and the remaining potassium salt is added in the form of an aqueous solution.

In a preferred embodiment of the invention, at least 90% by weight of the potassium sulphate used for the granulation consists of particles with a diameter smaller than 2.0 mm, and in particular smaller than 1.0 mm. At least 90% by weight of the potassium sulphate will preferably have a particle size ranging between 0.01 and 2.0 mm, and preferably 0.02 and 1.0 mm. The d₅₀ value of the potassium sulphate particles (weight average of particle size) used for granulation as a rule ranges between 0.05 and 1.1 mm, and in particular between 0.1 mm and 0.7 mm.

The particle sizes stated here and below can be determined by sieve analysis down to a particle size of 150 μm, and by laser diffraction methods for smaller particle sizes.

At least 90% by weight of the particulate potassium chloride in the form of a dust as a rule exhibit a particle size smaller than 0.2 mm, and in particular smaller than 0.1 mm. The particle size of at least 90% by weight of the particulate potassium salt will preferably range between 0.01 mm and 0.2 mm, and preferably between 0.02 mm and 0.1 mm. The d₅₀ value of the potassium salt particles (weight average of particle size) used for granulation as a rule ranges between 0.01 and 0.2 mm. The potassium chloride can naturally also be used as a solid with larger particle sizes, but the particle size should be selected in a manner ensuring an even distribution in the granulate.

In one embodiment of the invention, the potassium chloride in the form of a dust has a bulk density ranging between 250 and 1300 kg/m³.

The potassium chloride is used in a quantity of 0.1 to 7.5% by weight, preferably 1.8 to 4.5%, particularly preferably 2.5 to 4.3%, always calculated as the weight proportion of the potassium chloride in relation to the potassium sulphate used.

In a preferred embodiment of the invention, the volume of water added before or during the pressing process ranges between 0.1 and 2.5% (by weight), preferably between 0.1 and 1.5%, particularly preferably between 0.3 and 1.2%, and/or of that added after the pressing process ranges between 0.1 and 2.5%, preferably between 0.1 and 1.5%, and particularly preferably between 0.1 and 1.2%. The entire volume of added water amounts to 3.5% as a maximum, always relating to the water-free potassium sulphate. The addition of water after the pressing process is meanwhile optional.

In a preferred embodiment of the invention, the pressure agglomeration includes a compacting of the mixture of potassium sulphate, potassium chloride and water with a roller press at a specific line force ranging between 30 and 100 kN/cm, preferably between 40 and 80 kN/cm, and particularly preferably between 45 and 75 kN/cm, relating to a roller diameter of 1000 mm and a median slug thickness of 10 mm.

For the purposes of the invention, the specific line force is understood as a force in relation to a unit of length. The line force is applied along a theoretical line across the roller width. The specific line force was determined on the basis of press roller diameters of 1000 mm and obtained median slug thicknesses of 10 mm.

In another embodiment of the invention, the slugs are moistened with water after the pressing process, in particular after and/or during the milling and/or grading. The volume of water added after the pressing process meanwhile preferably ranges between 0.1 and 2.5%, preferably 0.1 and 1.5%, particularly preferably between 0.3 and 1.2%. The total volume of added water amounts to 3.5% as a maximum, always relating to the water-free potassium sulphate. The water can also be added in an after-treatment of the already provided granulate, e.g. on a maturing conveyor or in a mixer.

The invention in hand permits the total water volume to be added in the granulation process all at once, or the water can also be added in partial quantities before, during and/or after the pressing process. For the purposes of this invention, “after the pressing process” is understood as an addition of water such as by spraying it on the produced and/or milled slugs and/or sieved granulate. “Before” and/or “during the pressing process” is understood as one or several aforementioned addition points in the inventive procedure before the completion step as a granulate.

In a preferred embodiment of the invention, the granulation is performed at a temperature ranging between 20 and 100° C.

The potassium sulphate powder and/or potassium chloride used for the granulation may furthermore contain small quantities of other fertilizer ingredients such as ammonium sulphate, ammonium nitrate, urea, DAP (diammonium phosphate, (NH₄)₂HPO₄), kieserite or also micronutrients, for example. The share of these ingredients will usually not exceed 10% by weight, relating to the total weight of the salt mixture. Examples of micronutrients in particular include salts containing boron, zinc and manganese. The share of these micronutrients will usually not exceed 5% by weight, in particular 1% by weight, relating to the total weight of the potassium sulphate.

The granulates produced by the method according to the invention are distinguished by a high mechanical stability, low dust formation rate, and good hygroscopic stability.

The information previously provided about preferred embodiments in connection with the inventive method also applies to the use in accordance with the invention.

### EXAMPLE

The inventive method, inventive potassium sulphate granulate and inventive use are explained in greater detail by the examples below. Table 1 shows an overview of the trials performed as examples 1 to 3, including the type and quantity of the components used. The potassium sulphate powder used was a fine SOP product from K+S Kali GmbH with the following characteristics:

Fine SOP product:
Potassium sulphate (K₂SO₄): 95.5% by weight
Other sulphates (MgSO₄, CaSO₄): 2.6 percent by weight
Other ingredients, mostly crystal water: 0.9% by weight
Moisture: 0.2% by weight
Grain size distribution: over 0.85 mm 1%; 0.5-0.85 mm 3%; 0.25-0.5 mm 12%; 0.15-0.25 mm 22%; 0.09-015 mm 29%; under 0.09 mm 33%;
SGN: 12 (size guide number)

It emerged that granulates with markedly improved mechanical properties could be obtained by the use of finely ground KCl and a 23% KCl solution in trial 3. The following table shows a summary of the most important results achieved so far. The settings of the laboratory roller press were identical in all three trials.

The following mixture variants were used:
Trial no. 1: SOP without additives (reference trial)
Trial no. 2: SOP with 1% water
Trial no. 3: SOP with KCl and 23% aqueous KCl solution (objective: 2.5% maximum chloride content in granulate)

Trial 3 shows that the stability values are significantly increased over the comparison trials so far after one and/or seven days (burst strength: 55 N/56 N) as the KCl content in the base mix rises. Although the stability values can also be reduced again by storage (trial 2), there are first indications that even higher burst strengths yet are achievable by an after-treatment with water.

| Trial no. | | 1 | 2 | 3 |
|---|---|---|---|---|
| Mixture used | SOP [g] | 4000 | 4000 | 3831.8 |
| | KCl [g] | — | — | 156.25 |
| | NaCl [g] | — | — | — |
| | Water [g] | — | 40 | — |
| | 23% NaCl solution [g] | — | — | — |
| | 23% KCl solution [g] | — | — | 51.95 |
| After day 1 | Burst strength [N] | 18 | 33 | 55 |
| | Abrasion [%] | 85 | 13 | 10 |
| After day 7 | Burst strength [N] | 22 | 30 | 56 |
| | Abrasion [%] | 50 | 18 | 10 |

The maximum water fraction arrived at mathematically amounts to ca. 2.0% by weight in the obtained granulate. The ignition loss was established by covering the substance with lead oxide, annealing it at 450-600° C. in a muffle furnace and determining the weight loss gravimetrically.

The breaking strength, abrasion and residual moisture of the produced granulates were determined by the following methods:

The average breaking strengths were determined with the help of the EWEKA tablet breaking resistance tester type TBH 425D based on measurements involving 56 individual agglomerates of 2.5 to 3.15 mm particle size.

The abrasion values were determined with the rolling drum method after Busch. The abrasion and compressive strength values were measured using granules of the 2.5 to 3.15 mm fraction.

The residual moisture was determined using a Mettler halogen dryer, type HR 73.

The measured values were determined directly after the trial and after a maturing period, i.e. a time span of 1 and 7 days. During the maturing period, the samples were stored at 22° C. and a humidity of 65%. If water was added, this could be done before or after the pressing process. The addition amounted to ca. 2% of H₂O in each case.

The pressure agglomeration (trials 1 to 3) was performed using a Bepex laboratory press, type L200/50, with two counter-rotating drums featuring rod-shaped indentations in the roller surface (roller diameter 200 mm, working width 50 mm). The laboratory press was operated with a specific press force of up to 30 kN/cm and roller speed of 6.2 rpm. The applied press force was varied in a manner ensuring that the maximum value was reached, i.e. until the power consumption of the stuffing screw was near the limit preceding its malfunction.

The milling of the slugs obtained by the compacting with the laboratory press was performed with a Hazemag impact mill. The impact mill featured 2 impact elements and had a rotor diameter of 300 mm. The gap size of the front impact element was set to 10 mm and that of the back impact element to 5 mm. The impact mill was operated with a rotor circumferential speed of 15 m/s.

The potassium chloride used was KCl as a commercially available Merck laboratory chemical.

1-13. (canceled)

14: A process for producing potassium sulphate granulates, comprising:
adding potassium chloride to the potassium sulphate in a granulation process in a quantity of 0.1 to 7.5% by weight, based on the potassium sulphate used.

15: The process according to claim 14, wherein the potassium chloride is added in the form of a dust with a maximum particle size of 200 μm or in the form of an aqueous solution.

16: The process according to claim 14, wherein part of the potassium chloride added is in the form of a dust with a maximum particle size of 200 μm, and a remaining quantity of the potassium chloride is in the form of an aqueous solution.

17: The process according to claim 14, wherein a volume of water added before or during the pressing process is between 0.1 and 2.5% by weight, and/or
wherein a volume of water added after the pressing process is between 0.1 and 2.5% by weight,
with the total volume of the added water amounting to 3.5% by weight as a maximum, the weight % being based on the water-free potassium sulphate.

18: The process according to claim 14, comprising:
compacting of the potassium chloride, potassium sulphate and water mixture;
wherein said compacting is performed as pressure agglomeration.

19: The process according to claim 18, wherein the pressure agglomeration comprises compacting of the mixture of potassium sulphate, potassium chloride and water with a roller press.

20: The process according to claim 19, wherein the pressure agglomeration comprises compacting of the mixture of potassium sulphate, potassium chloride and water with a roller press at a specific line force ranging between 30 and 100 kN/cm, based on a roller diameter of 1000 mm and an average slug thickness of 10 mm.

21: The process according to claim 18, wherein the compacting of the mixture of potassium sulphate, potassium chloride and water is performed with a roller press and followed by a subsequent milling and grading of slugs obtained from the compacting.

22: The process according to claim 21, wherein the slugs are moistened with water after the pressing process.

23: The process according to claim 14, wherein the granulation is performed at a temperature ranging between 20 and 100° C.

24: A potassium sulphate granulate obtainable by a process according to claim 14.

25: The potassium sulphate granulate according to claim 24, comprising a potassium chloride content ranging between 0.1 and 7.5% by weight, based on the amount of the potassium sulphate used.

26: A method for improving mechanical properties of potassium sulphate granulates, comprising:
adding potassium chloride to the potassium sulphate during a granulation process.

27: The method according to claim 26, wherein the burst strength and/or abrasion resistance of said potassium sulphate granulates is increased compared to potassium sulphate granulates which do not comprise potassium chloride.
